(19) United States
(12) Patent Application Publication
(10) Pub. No.: US 2009/0251844 A1
(43) Pub. Date: Oct. 8, 2009

(54) Transformer Assembly and Methods of Use

(76) Inventor: Mark Head, Bayfield, CO (US)

Correspondence Address: Leyendecker & Lemire, LLC, C/O PORTFOLIO IP, P.O. BOX 52050, MINNEAPOLIS, MN, 55402, US

(21) Appl. No.: 12/098,336

(22) Filed: Apr. 4, 2008

(51) Int. Cl. H01H 9/00

(52) U.S. Cl. 361/268

(57) ABSTRACT

A transformer assembly is described. Embodiments of the transformer assembly are adapted to facile disconnection and removal of a transformer from the transformer assembly without disconnecting metered service power lines from secondary connector blocks. Moreover, embodiments of the transformer assembly are adapted to de-energize the transformer without interrupting primary power to downstream devices, and to safely and easily park energized or de-energized connectors such as loadbreak elbows during transformer maintenance. Methods of using the transformer assembly are also described.

### FIELD OF THE INVENTION

The present invention relates generally to transformers used to distribute electric power, and to electrical connections used in conjunction with such transformers.

### BACKGROUND

Systems for distributing electric power from generating facilities to users such as businesses and residences usually employ transformers to reduce voltage. Relatively low electrical potential delivered to residential and some business users is typically around 120 to 600 volts, whereas electric power is usually distributed at much higher voltage from generators to transformers located in the vicinity of users. Transformers are thus used to step voltage down from relatively high primary voltage to relatively low secondary voltage. Electric power at secondary voltage is typically distributed from transformers to meters, with one transformer typically serving multiple meters.

Underground primary power configurations presently in use for underground electrical power distribution typically include a junction box or similar device that provides a means for continuing a primary power line downstream in one or more directions, in addition to providing primary voltage to a transformer. Downstream, a primary power line typically provides power to one or more additional transformers. Transformers typically provide primary voltage out in only one direction.

Maintenance or replacement of a transformer requires that it be de-energized by interrupting primary power to the transformer. Typically, with devices currently in use, a transformer is de-energized by disconnecting a primary high voltage connection. Such a high voltage connection sometimes comprises a loadbreak elbow and a bushing at a junction box or a transformer. Interrupting power by disconnecting a loadbreak elbow from a bushing not only de-energizes the transformer being modified, but usually interrupts power downstream as well. Thus, downstream electric power users have electric power interrupted, as do those users supplied by the transformer being serviced.

Where a transformer is removed or replaced, it should be disconnected from a junction box after being de-energized. With some underground primary power configurations presently in use for underground electrical power distribution, a transformer is de-energized for removal by disconnecting an energized primary loadbreak elbow from the transformer and attempting to insulate the energized primary loadbreak elbow with a device such as a rubber mat or rubber blanket.

Primary connections in transformer assemblies typically comprise loadbreak elbows adapted to disconnect and reconnect at bushings. Loadbreak elbow and bushing connections are sometimes preferable to switches for use on the primary side because high voltage switches are vulnerable to arcing and other problems within the knowledge of persons of ordinary skill in the art, associated with interrupting high voltage circuits. Primary loadbreak elbows that have been disconnected need to be temporarily secured at other well insulated positions, such as isolated, electrically insulated bushings, in order to be stored safely. Thus junction boxes and transformers require such an isolated bushing to “park” disconnected, but still energized, loadbreak elbow connectors. Line tools such as a shot gun (also known as a shot-gun stick) enable electric utility workers to disconnect and maneuver high voltage loadbreak elbows without excessive danger caused by exposure to high voltage. Loadbreak elbow and bushing connections are thus widely accepted devices for providing relatively safe high primary power connections in transformer assemblies. Loadbreak elbow and bushing connections are generally not used on the secondary side of transformer assemblies.

In addition to requiring interruption of downstream primary power when de-energizing a transformer for maintenance or replacement, current transformer design requires that connections between a user's electric meter and a transformer be disconnected at a secondary block of a transformer assembly, particularly where a transformer is being removed or replaced. Such interruption frequently requires disconnecting a separate secondary power line for each meter, requiring disconnection of as many as 18 or more secondary power lines before removing one transformer. Disconnecting and then reconnecting secondary power lines for each meter is inefficient; it is frequently time consuming and tedious.

Underground primary power line configurations currently in use typically have a transformer and junction box positioned at separate locations. Thus a single transformer and single junction box sometimes requires two utility boxes in close proximity to each other, which many users find unsightly.

In summary, underground primary power line configurations currently in use require that downstream primary service be interrupted for the transformer to be de-energized. Moreover, a transformer in a typical contemporary assembly must be disconnected both from a junction box or upstream transformer and from individual metered connections at a secondary block, in order to remove or replace the transformer. Having to replace both transformer connections and a plenitude of secondary block connection increases maintenance time, which increases the interval during which a transformer is de-energized. Downstream users are deprived of electric power during this interval. Finally, underground primary systems may consist of transformers and junction boxes disposed at separate locations, requiring two utility boxes in close proximity of each other. Such configuration is an inefficient use of space and material, and is unnecessarily aesthetically disruptive.

### BRIEF DESCRIPTION OF THE DRAWINGS

FIG. 1 is a front view of a transformer assembly according to one embodiment of the present invention.

FIG. 2 is an oblique view of a secondary side of a transformer assembly, with the transformer suspended above a medial wall and secondary components, according to one embodiment of the present invention.

FIG. 3A is an isometric view of a primary junction module and secondary blocks according to one embodiment of the present invention.

FIG. 3B is an isometric view of a transformer according to one embodiment of the present invention.

FIG. 4A is a perspective, front view of a transformer assembly according to one embodiment of the present invention

FIG. 4B is an isometric view of a transformer assembly with a modular transformer partially separated from a primary junction module and secondary blocks, according to one embodiment of the present invention.

FIG. 5 is a side view of a quick release locking mechanism according to one embodiment of the present invention.

FIG. 6 is an oblique view of a medial wall according to one embodiment of the present invention.

### DETAILED DESCRIPTION

Embodiments of the present invention include transformer assemblies comprising primary junction modules located in very close proximity to their respective transformers, forming modular, compact integrated units. So configured, a transformer and primary junction module can share a single mounting pad and ground sleeve, creating a single utility box assembly. Despite their close proximity, however, embodiments have primary junction modules and transformers that are modular and separable, such that a transformer can be readily removed from a transformer assembly with no interruption and little or no disturbance to a primary junction module, and no interruption to downstream primary power. Embodiments of the present invention include secondary blocks and secondary block terminals. Embodiments of secondary block terminals provide connections for metered secondary power lines to connect to secondary blocks.

Embodiments comprise connections on the secondary side of the transformer assembly that enable disconnecting a transformer from metered secondary power lines by disconnecting the transformer from secondary blocks, instead of requiring disconnection of each metered secondary power line from the secondary block. Thus the number of secondary connections that must be disconnected in order to remove or replace a transformer is typically reduced, where the transformer serves multiple metered secondary power lines.

Embodiments also comprise a transformer that is readily de-energized by interrupting primary power connectivity between the primary junction module and the transformer, without de-energizing the primary junction module. Primary power to a transformer is thus interrupted, but continues through the primary junction module to other downstream transformers and users.

### Terminology

The terms and phrases as indicated in quotation marks (“ ”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive; rather the term is inclusive, meaning “either or both.”

References in the specification to “one embodiment”, “an embodiment”, “another embodiment, “a preferred embodiment”, “an alternative embodiment”, “one variation”, “a variation” and similar phrases mean that a particular feature, structure, or characteristic described in connection with the embodiment or variation, is included in at least an embodiment or variation of the invention. The phrase “in one embodiment”, “in one variation” or similar phrases, as used in various places in the specification, are not necessarily meant to refer to the same embodiment or the same variation.

The term “couple” or “coupled” as used in this specification and appended claims refers to an indirect or direct connection between the identified elements, components, or objects. Often the manner of the coupling will be related specifically to the manner in which the two coupled elements interact.

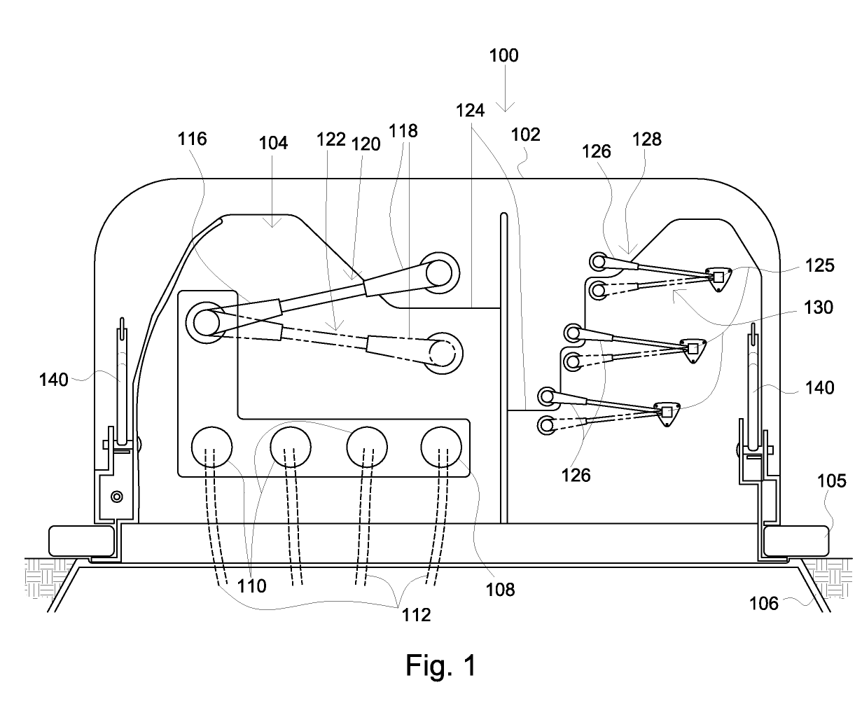

The term “compact integrated unit” as used in this specification and appended claims, refers to a transformer assembly wherein the individual components of the transformer assembly, including, but not limited to, a transformer, a primary junction module, a primary connecting member, a secondary block, or a secondary connecting member, are adapted to fit together in very close proximity, as a relatively densely packed assembly. Such adaptation is typically embodied in complementary shapes of components, and complementary shaped adjacent sides of components, that allows the components to be assembled densely packed, in very close proximity, together. Embodiments of the present invention illustrated in FIGS. 1, 3A, 3B, 4A and 4B exemplify the way that a transformer and other assembly components are adapted to fit in close proximity to form a compact integrated unit. In contrast, transformer assembly components disclosed in FIGS. 1-5 of U.S. Pat. No. 3,443,113 and FIG. 1 of U.S. Pat. No. 3,488,563 are not adapted to fit in close proximity or be densely packed together. Thus, the transformer assemblies of U.S. Pat. Nos. 3,443,113 and 3,488,563 are not compact integrated units, despite sharing a vault and not being separated by great distance. Some embodiments of compact integrated units are adapted to share a common mounting pad. Mounting pads are typically, but not necessarily, concrete.

The terms “connector” or “connectors,” or “electrical connector,” as used in this specification and appended claims, refer to devices adapted to making electrical connections, such as, but not limited to, loadbreak elbows. Connectors typically comprise or are disposed on primary or secondary connecting members. Primary connectors are adapted to conduct primary power and secondary connectors are adapted to conduct secondary power.

The terms “parking port” or “parking ports,” as used in this specification and appended claims, refers to electrically isolated devices at which an electric connector such as a loadbreak elbow may be stored (parked). Embodiments of parking ports are adapted to engage energized or de-energized electrical connectors. An insulated parking port is electrically isolated and relatively well electrically insulated, and thus adapted to substantially safely engage an energized loadbreak elbow or other energized connector. Because a parking port is not part of an electrical circuit, it is electrically isolated; it does not conduct electricity to ground or to a downstream electrical component. An insulated parking port typically plays a role in interrupting a circuit by accepting an energized connector, such as a loadbreak elbow, that has been disconnected from a circuit. A primary insulated parking port is adapted to substantially safely accommodate primary voltage, and therefore would be a safe place to park or store an energized primary connector such as a loadbreak elbow.

The terms “parking station” or “parking stations,” as used in this specification and appended claims, refers to a device at which an electric connector such as a loadbreak elbow may be “parked” when the electric connector is disconnected, so as to open the circuit in which the electric connector participates. A parking station may be isolated, or amalgamated, and may be energized or de-energized. An energized electric connector may be parked at an energized parking station. For example, a primary loadbreak elbow, energized at a primary voltage of 7200 V, may be disconnected from a primary bushing on a transformer, and “parked” at a parking station that is also energized at potential of 7200 V. Alternatively, the energized primary loadbreak elbow could be parked at an isolated, well insulated parking station (also known as an insulated parking port). A parking port is a particular type of parking station, i.e. an electrically isolated parking station.

The term “amalgamated,” as used in this specification and appended claims, refers to an electrical component or member that is part of, participates in, or is designed to be part of, an electric circuit. Amalgamated is the opposite of isolated. Thus a parking port is not amalgamated.

The term “isolated,” as used in this specification and the appended claims, refers to an electrical component or member that is not part of or does not participate in, nor is it designed to participate in, an electric circuit. Isolated is the opposite of amalgamated.

The terms “amalgamated terminal,” “amalgamated primary terminal” or “amalgamated secondary terminal,” as used in this specification and appended claims, refers to terminals adapted to engage loadbreak elbows or other electrical connectors, and that are part of, or become part of, electrical circuits. Amalgamated terminals are NOT used to “park” loadbreak elbows or other connectors. Conversely, they are where loadbreak elbows or other connectors are engaged as part of an active electrical circuit. An amalgamated terminal is typically, but not necessarily, a bushing. As used in this application, an amalgamated terminal may be de-energized and still be considered an amalgamated terminal.

The terms “transformer” or “transformers,” as used in this specification and appended claims, refers to an electrical device familiar to persons of ordinary skill in the art, adapted to transform electric power at a primary voltage to electric power at a secondary voltage. A transformer typically comprises an enclosure that protects and contains components, such as windings and cooling fluid.

The term “primary conductivity,” as used in this specification and appended claims, refers to electrical conductivity between structures such that electricity at primary power can be readily and substantially safely conducted between the structures. For example, if a transformer assembly is adapted to handle a primary potential of 7200 V, transformer assembly structures that have or are in primary conductivity are connected in such a way that electricity at 7200 V and appropriate amperage can be readily and substantially safely conducted between the structures. Structures in primary conductivity with each other are connected by material that readily conducts electricity at primary power levels. Structures need not be energized to be in primary conductivity.

The term “secondary conductivity,” as used in this specification and the appended claims, refers to electrical conductivity between structures such that electricity at secondary power can be readily and substantially safely conducted between the structures. For example, if a transformer assembly is adapted to handle a secondary potential of 120 to 600 V, transformer assembly structures that have or are in secondary conductivity are connected in such a way that electricity at 120 to 600 V and appropriate amperage can be readily and substantially safely conducted between the structures. Structures in secondary conductivity with each other are connected by material that readily conducts electricity at secondary power levels. Structures need not be energized to be in secondary conductivity.

The terms “secondary block” or “secondary blocks,” as used in this specification and the appended claims, refers to structures typically found in transformer assemblies currently in use, and in embodiments of the present invention. A user of secondary electrical power typically has at least one electrical connection between the user's electric meter and a terminal at a secondary block in a transformer assembly. A typical transformer, both in conventional transformers currently in use and in embodiments of the present invention, may have multiple secondary blocks, and each secondary block can have multiple metered connections at terminals at the secondary blocks. By this means, a typical transformer can serve multiple meters.

The terms “secondary component” or “secondary components,” as used in this specification and the appended claims, refers to structures relating to a secondary side of a transformer, including secondary bushings, secondary connecting members, secondary blocks, secondary power lines, and secondary connectors such as secondary loadbreak elbows. Secondary power lines are also known as service power lines.

### A First Embodiment Transformer Assembly

A first embodiment transformer assembly 100 is illustrated in FIG. 1. The first embodiment transformer assembly comprises a transformer 102, a medial wall 124, a primary junction module 104, a primary connecting member, and a secondary connecting member. The first embodiment transformer assembly further comprises a mounting pad 105 on which the transformer sets. The mounting pad sets on a bottom flange of the medial wall (not shown), the medial wall, and the transformer residing on top of the ground sleeve 106.

The first embodiment primary junction module 104 comprises a primary input terminal 108 and multiple primary output terminals 110. In this embodiment, primary power lines 112 bring primary power to or from the primary junction module. The first embodiment primary junction module achieves primary conductivity with the transformer 102 through a primary connecting member, the primary connecting member comprising a first primary loadbreak elbow 116 in primary conductivity with a second primary loadbreak elbow 118.

Where the first embodiment primary connecting member is in a first primary configuration 120, the first primary loadbreak elbow 116 is installed at an amalgamated primary bushing (not shown, hidden behind the first primary loadbreak elbow) disposed on the primary junction module 104, and the second primary loadbreak elbow 118 is installed on an amalgamated primary bushing (not shown, hidden behind the second primary loadbreak elbow where the primary connecting member is in a first primary configuration) on the transformer. So configured, the amalgamated primary bushing on the transformer is in primary conductivity with the primary junction module 104, and is thus configured to deliver primary power to the primary side of the transformer.

Alternatively, the first embodiment primary connecting member is in a second primary configuration 122, wherein the first primary loadbreak elbow 116 is installed on the amalgamated primary bushing disposed on the primary junction module 104, and the second primary loadbreak elbow 118 is “parked” at a insulated parking port (not shown, hidden behind the second primary loadbreak elbow where the primary connecting member is in a second primary configuration) disposed on a medial wall 124. Typically, the second primary loadbreak elbow is energized in both the first primary configuration and the second primary configuration. The primary junction module 104 of the first embodiment transformer assembly 100 is disposed on the medial wall, which stands between the transformer 102 and the primary junction module.

The first embodiment primary connecting member is adapted to adjust from the first primary configuration 120 to the second primary configuration 122, by disengaging the second primary loadbreak elbow 118 from the amalgamated primary bushing (not shown) on the transformer and installing the second primary loadbreak elbow in the insulated parking port (not shown) disposed on the medial wall 124. Primary conductivity in a first embodiment transformer assembly between the primary junction module 104 and the transformer 102 is thus interrupted. Typically, primary power to the transformer is also interrupted, but without substantially interrupting downstream power to other transformers, because primary conductivity among the primary input terminal 108 and primary output terminals 110 persists. Also typically, but not necessarily, the second primary loadbreak elbow 118 of the first embodiment remains energized in the second primary configuration, i.e. a parked position.

Similarly, the first embodiment primary connecting member is readily moved from the second primary configuration 122 to the first primary configuration 120, thereby achieving primary conductivity between the primary junction module 104 and the transformer 102. Typically, the primary side of the transformer is thus energized.

In some embodiments, primary conductivity between a primary junction module and a transformer is interrupted, without substantially affecting primary conductivity among primary input terminals and primary output terminals, by disengaging a first primary loadbreak elbow from an amalgamated primary bushing on the primary junction module. In such embodiments, the first primary loadbreak elbow is thus de-energized, and can be parked at a parking port. Typically, such a primary parking port is disposed on the transformer rather than on a medial wall or on the primary junction module.

The first embodiment transformer 102 achieves secondary conductivity with any of three secondary blocks 125 through three secondary connecting members, each secondary connecting member comprising a secondary block 125 having secondary conductivity with a secondary loadbreak elbow 126. Typically, one secondary connecting member is neutral rather than hot.

Where a first embodiment secondary connecting member is in a third configuration 128, a secondary loadbreak elbow 126 is installed on an amalgamated secondary bushing (not shown, hidden behind the secondary loadbreak elbow in the third configuration) disposed on the transformer 102. So configured, the amalgamated secondary bushing on the transformer 102 is in secondary conductivity with the secondary block 125, and the secondary connection is thus adapted to deliver secondary power from the secondary side of the transformer.

Alternatively, a first embodiment secondary connecting member is in a fourth configuration 130, wherein a secondary loadbreak elbow 126 is “parked” at a secondary parking port (not shown, hidden behind a secondary loadbreak elbow in a fourth configuration) disposed on a medial wall 124. So configured, secondary conductivity between the amalgamated secondary bushing on the transformer and the secondary block is interrupted.

First embodiment secondary connecting members are readily moved from a third configuration 128 to a fourth configuration 130, by disengaging a secondary loadbreak elbow 126 from an amalgamated secondary bushing (not shown) on the transformer, and installing secondary loadbreak elbows at secondary parking ports (not shown) disposed on the medial wall 124. Secondary conductivity between a secondary block 125 and the transformer 102 is thus interrupted, as is physical connection between the secondary block and the transformer. With electrical conductivity and physical connectivity between the transformer and secondary blocks absent, the transformer is free to be removed from its close proximity to the medial wall 124 and secondary blocks without disconnecting or disturbing individual metered secondary power lines (not shown) from terminals (not shown) disposed on the secondary blocks.

The first embodiment transformer assembly 100 further comprises two quick release locking levers 140, the locking levers being pivotably coupled to the transformer 102 and disposed in an upright position, the upright position being an unlocked configuration. When the first embodiment transformer 102 is installed in very close proximity to other transformer assembly components to form a compact integrated unit, the locking lever 140 locks the transformer in place by moving about its pivot into a horizontal position (not shown), wherein the locking lever engages an anchor plate (not shown), the anchor plate being securely coupled to the ground sleeve 106. Thus where the first embodiment transformer assembly is configured with a locking lever in a horizontal, locked, position, the transformer is secured in place by the action of the locking lever engaging the anchor plate. In the first embodiment, the locking lever, being coupled to the transformer, holds the transformer in place on the ground sleeve by engaging the anchor plate, which is secured to the ground sleeve.

### A Second Embodiment Transformer Assembly

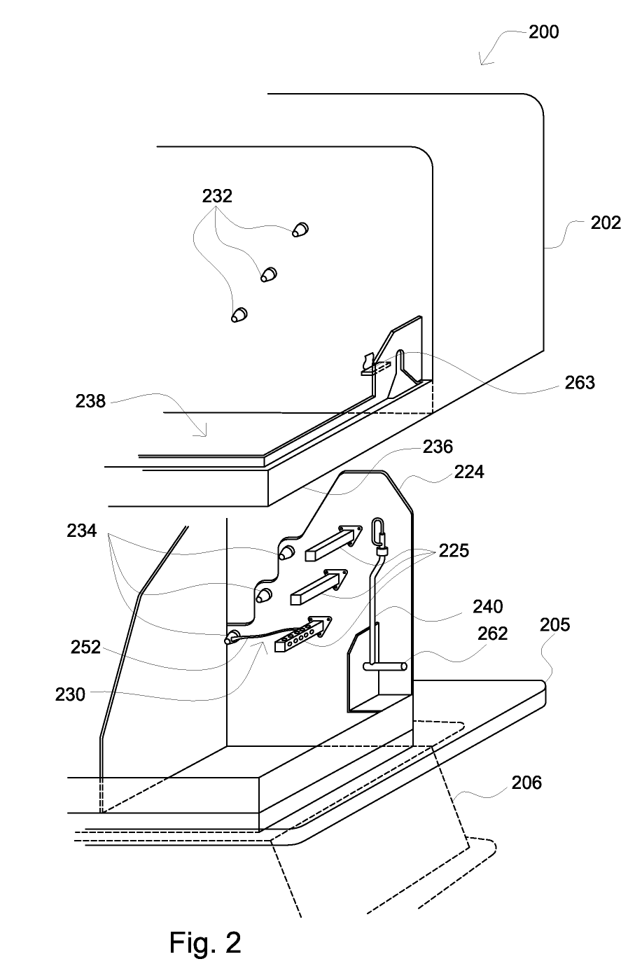

A second embodiment transformer assembly 200 is illustrated in FIG. 2. The second embodiment transformer assembly comprises a transformer 202 on which is disposed three amalgamated secondary bushings 232, and a medial wall assembly 224 on which is disposed three secondary blocks 225 and three secondary parking ports 234. The second embodiment transformer assembly further comprises a mounting pad 205 on which resides the transformer, and below which resides a ground sleeve 206.

The second embodiment transformer 202 further comprises a forward base member 236 and transformer aperture 238. The transformer aperture of the second embodiment transformer assembly is adapted to allow components such as a medial wall assembly 224, secondary blocks 225, secondary connecting members, or a primary junction module to extend through or reside in the transformer aperture.

FIG. 2 illustrates a second embodiment transformer 202 that is suspended above the mounting pad 205 on which the transformer rests when in operation. When set in place, the second embodiment transformer resides in very close proximity to other second embodiment components such as a medial wall assembly 224, secondary blocks 225, secondary connecting members, or a primary junction module (not shown). After being set into place on the mounting pad, the second embodiment transformer is readily put in condition of secondary conductivity with secondary blocks 225 by adjusting a second connecting member 252 from a fourth configuration 230 to a third configuration (not shown). A secondary connecting member in a fourth configuration 230 is adjusted to a third configuration (not shown) by disengaging a secondary connecting member 252 from its secondary parking port 234 and installing the secondary loadbreak elbow on an amalgamated secondary bushing 232 disposed on a transformer 202.

Because the second embodiment transformer 202 is adapted to be installed in very close proximity to other components such as a medial wall assembly 224, secondary blocks 225, secondary connecting members 252, or a primary junction module (not shown), with those enumerated other components extending through or residing in a transformer aperture 238, the second embodiment transformer assembly comprises a compact integrated unit.

The second embodiment transformer assembly 200 further comprises a locking lever 240, the locking lever being pivotably coupled to the medial wall 224 and disposed in an upright position, the upright position being an unlocked configuration. When the second embodiment transformer 202 is installed in very close proximity to other transformer assembly components to form a compact integrated unit, the locking lever 240 locks the transformer in place by moving about its pivot into a horizontal position (not shown), wherein the locking lever engages the anchor plate 263. In the second embodiment transformer assembly, the locking lever is coupled to the ground sleeve, and the anchor plate is coupled to the transformer 202. Thus where the first embodiment transformer assembly is configured with the locking lever in a horizontal, locked, position, the transformer is secured in place by the action of the locking lever engaging the anchor plate.

### A Third Embodiment Transformer Assembly

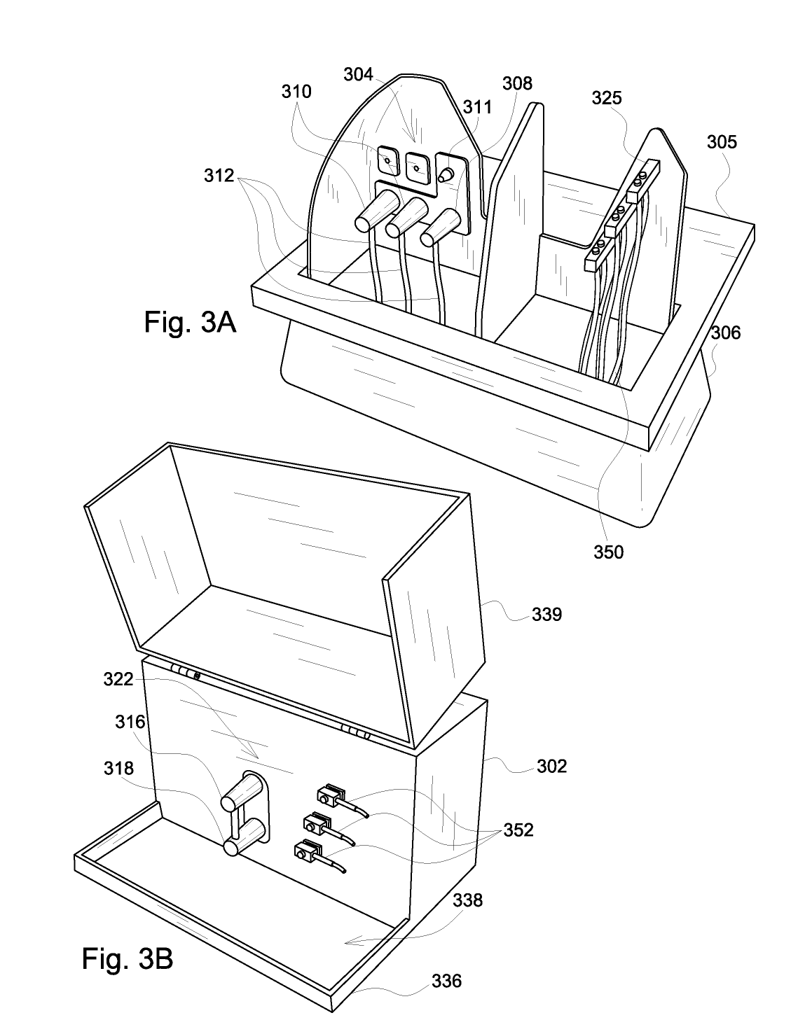

Third embodiment transformer assembly components are illustrated in FIGS. 3A and 3B, with the transformer 302 separate from a mounting pad 305 and ground sleeve 306, and disconnected from the primary junction module 304 and secondary blocks 325. As illustrated in FIG. 3A, the third embodiment transformer assembly comprises a primary junction module 304, a primary connecting member and a secondary connecting member.

The third embodiment primary junction module 304 comprises a primary input terminal 308, two primary output terminals 310, and an amalgamated primary bushing 311, the primary input terminal, primary output terminals, and amalgamated primary bushing being in primary conductivity with each other. In this embodiment, primary power lines 312 bring primary power to or from the primary junction module. The third embodiment transformer assembly further comprises secondary blocks 325, to which metered secondary power lines 350 connect.

The third embodiment transformer assembly further comprises a transformer 302, as illustrated in FIG. 3B. The third embodiment transformer 302 comprises a primary connecting member, the primary connecting member comprising a first primary loadbreak elbow 316 in primary conductivity with a second primary loadbreak elbow 318. As illustrated in FIG. 3B, the third embodiment primary connecting member is in a second primary configuration 322, wherein the third embodiment transformer is not in primary conductivity with a primary junction module, and is therefore de-energized. The third embodiment first primary loadbreak elbow is disposed on a primary parking port (not shown, hidden behind the first primary loadbreak elbow).

The transformer 302 of the third embodiment transformer assembly further comprises a forward base member 336, transformer aperture 338, transformer cover 339, and secondary connecting members 352. The third embodiment secondary connecting members are adapted to readily connect to and disconnect from secondary blocks. The third embodiment transformer aperture is adapted to accept transformer assembly components illustrated in FIG. 3A, which extend through or reside in the transformer aperture, where the third embodiment transformer is fully assembled with the transformer resting on the mounting pad 305.

### A Fourth Embodiment Transformer Assembly

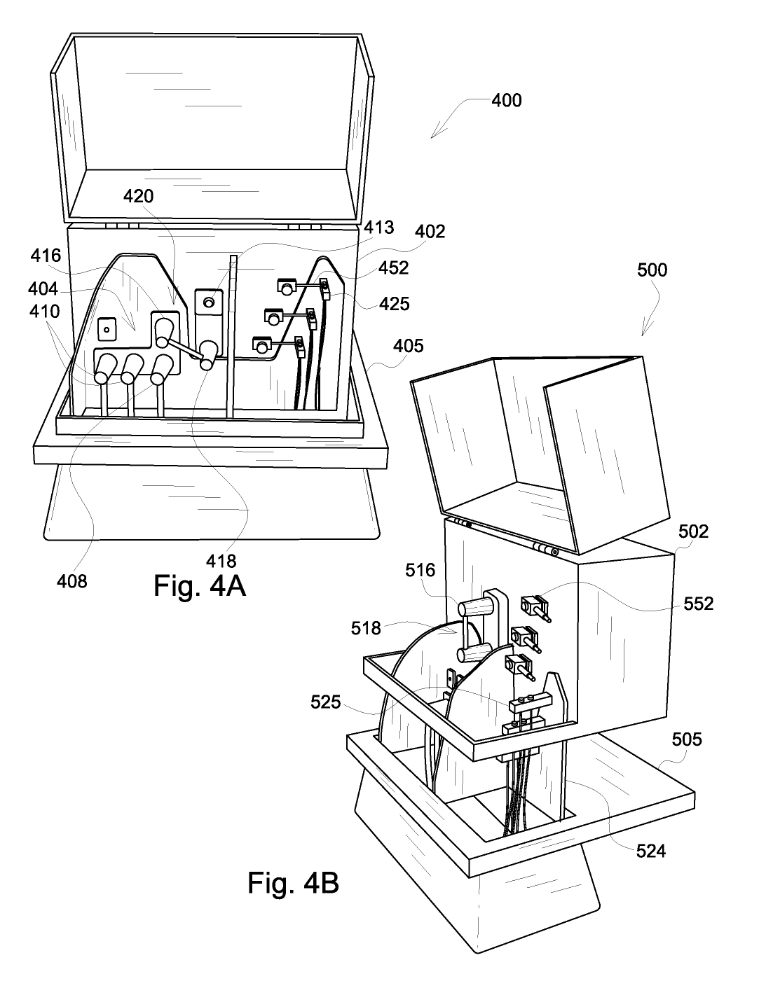

A fourth embodiment transformer assembly 400 is illustrated in FIG. 4A, with a transformer 402 installed on a mounting pad 405 and connected to a primary junction module 404 and secondary blocks 425. The fourth embodiment primary connecting member is in a first primary configuration 420, with a first primary loadbreak elbow 416 installed at an amalgamated primary bushing (not shown, hidden behind the first primary loadbreak elbow). So configured, the fourth embodiment transformer is in primary conductivity with the primary junction module, and is energized when the primary junction module is energized. The fourth embodiment transformer assembly is a compact integrated unit because its components are adapted, by use of complementary adjacent sides and other complementary shapes, to fit together in very close proximity as a densely packed assembly.

The fourth embodiment primary connecting member is adapted to adjust to a second primary configuration (not shown), wherein the first primary loadbreak elbow 416 is installed on a primary parking port 413, the primary parking port being disposed on the fourth embodiment transformer 402. In a second primary configuration, the fourth embodiment primary connecting member, including the first primary loadbreak elbow, is not in primary conductivity with the primary junction module 404, and is thus de-energized. Accordingly, the fourth embodiment transformer 402 is also de-energized. Where the fourth embodiment transformer assembly has a primary connecting member in a second primary configuration, the transformer can be removed from the transformer assembly without interrupting primary conductivity among primary input 408 and output terminals 410. The second primary loadbreak elbow 418 of the fourth embodiment transformer assembly remains installed on the transformer in both first and second primary configurations.

The fourth embodiment transformer assembly 400 further comprises secondary connecting members 452, the secondary connecting members being adapted to provide secondary conductivity between the transformer 402 and the secondary blocks 425. The fourth embodiment secondary blocks are in secondary conductivity with metered secondary power lines. The secondary connecting members are further adapted to being readily physically disconnected from the secondary blocks, thereby interrupting secondary conductivity between the transformer and the secondary blocks. Where the secondary connecting members are physically disconnected from the secondary blocks, the transformer can be removed from the transformer assembly without physically disconnecting secondary power lines from the secondary blocks. The fourth embodiment transformer assembly is modular because the transformer is adapted to be readily removed from the assembly with minimal disturbance to other transformer assembly components.

### A Fifth Embodiment Transformer Assembly

A fifth embodiment transformer assembly 500 is illustrated in FIG. 4B. The fifth embodiment transformer assembly is identical to the fourth embodiment transformer assembly, except that in the fifth embodiment, the secondary connecting members 552 have been disconnected from the secondary blocks 525, and the first primary loadbreak elbow is disposed at a primary parking port in a second primary configuration 418. Accordingly, the fifth embodiment transformer is disconnected from both the primary junction module and the secondary blocks, and is being lifted off the mounting pad 505 and removed from the fifth embodiment transformer assembly.

FIG. 4B illustrates how adjacent sides of the fifth embodiment transformer 502 and other transformer assembly components such as the medial wall assembly 524 are adapted to fit in very close proximity. The fifth embodiment transformer assembly 500, when assembled densely packed together, is therefore a compact integrated unit. FIG. 4B also illustrates that the fifth embodiment transformer assembly is modular because the transformer is readily removed from the mounting pad and the transformer assembly without substantially disturbing other transformer assembly components.

### A Sixth Embodiment Transformer Assembly

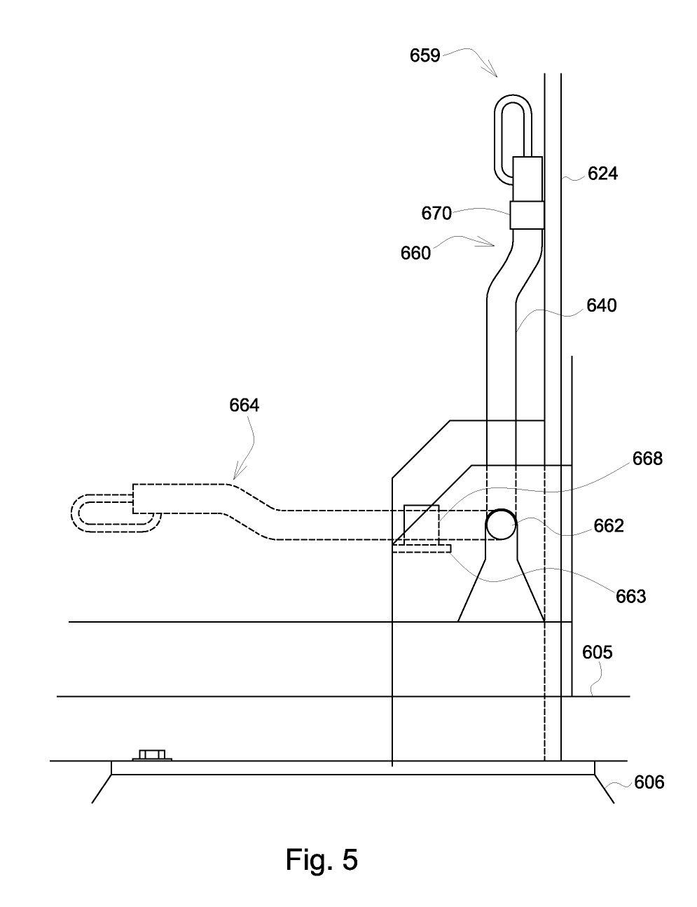

A sixth embodiment transformer assembly is illustrated in FIG. 5, the sixth embodiment transformer assembly comprising a quick release locking mechanism 659. The quick release locking mechanism comprises a locking lever 640, the locking lever being pivotably coupled to a medial wall assembly 624 and disposed in an upright position 660, which is an unlocked configuration. The sixth embodiment locking lever is secured in the upright position by an upper level clip 670. The sixth embodiment locking lever 640 locks a transformer in place by the lever moving about its pivot 662 into a horizontal position 664, wherein the locking lever engages an anchor plate 663. In the sixth embodiment quick release locking mechanism, a lower lever clip 668 secures the locking lever in the horizontal position. The sixth embodiment anchor plate 663 is coupled to a transformer, and the sixth embodiment locking lever is coupled to the ground sleeve 606 via the medial wall assembly 624. Thus, where the sixth embodiment transformer assembly is configured with the locking lever in a horizontal, locked, position, the transformer is secured in place by the action of the locking lever engaging the anchor plate 663.

Embodiments of transformer assemblies typically, but not necessarily, have two quick release locking mechanisms, one quick release locking mechanism on each of the left and right sides of the assembly. Quick release locking mechanisms are adapted to quickly adjust from a locked position, where a transformer is held securely in place on a mounting pad proximate other transformer assembly components, to an unlocked position, in which the transformer is not held securely in place, and is therefore more adapted to being removed from the transformer assembly. Quick release locking mechanisms typically replace conventional transformer securing means, such as multiple large nuts, and bolts or studs. Quick release locking mechanisms are adapted to adjust from one of a secure or unsecure configuration, to the other of a secure or unsecure configuration, configuration, more quickly than conventional transformer securing means.

### A Seventh Embodiment Transformer Assembly

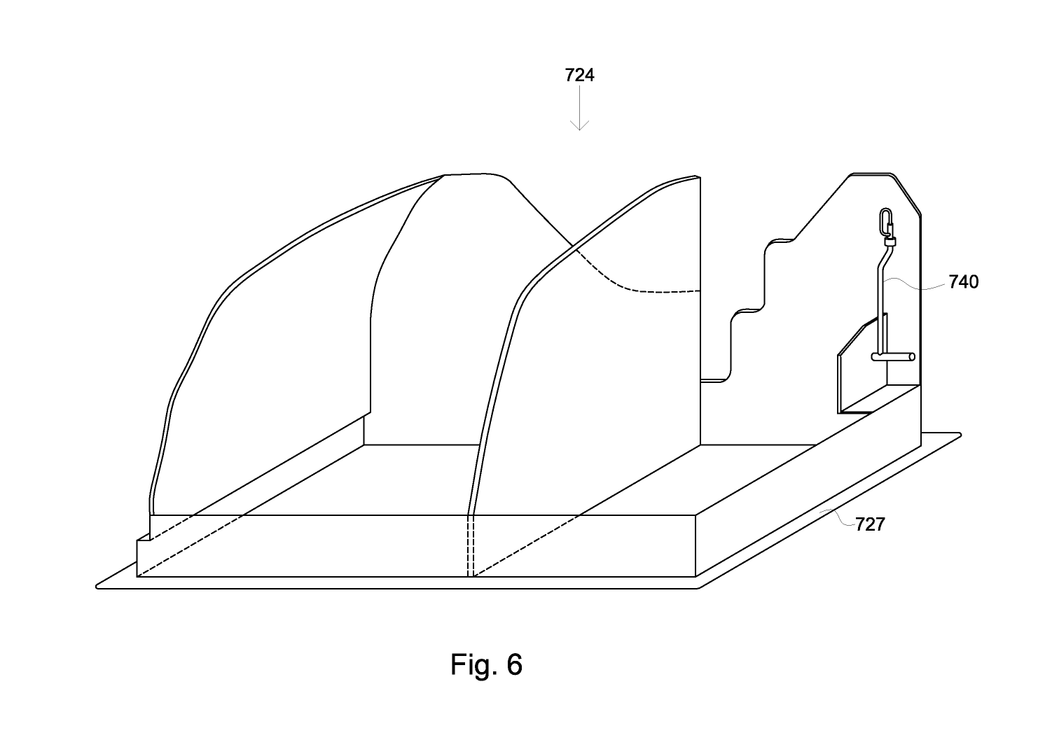

A seventh embodiment transformer assembly is illustrated in FIG. 6, the seventh embodiment transformer assembly comprising a medial wall assembly 724, on which is disposed a locking lever 740. The medial wall assembly comprises a flange 727.

Typically, embodiments of the present invention comprise a medial wall assembly 724 residing on and coupled to a ground sleeve, with a mounting pad residing on a flange 727 of the medial wall assembly and part of the medial wall assembly extending up through an aperture in the mounting pad. In some embodiments, a transformer sets on the mounting pad, with a medial wall and other transformer assembly components extending through a transformer aperture, and an anchor plate acting to couple the transformer to the medial wall by engaging a locking lever 740.

### Alternative Embodiments and Variations

The various embodiments and variations thereof, illustrated in the accompanying Figures and/or described above, are merely exemplary and are not meant to limit the scope of the invention. It is to be appreciated that numerous other variations of the invention have been contemplated, as would be obvious to one of ordinary skill in the art, given the benefit of this disclosure. All variations of the invention that read upon appended claims are intended and contemplated to be within the scope of the invention.

I claim:

1. A transformer assembly comprising:
a transformer; and
a primary junction module, the primary junction module comprising (i) one or more primary input terminals, and, (ii) one or more primary output terminals, the one or more primary input terminals having primary conductivity with at least one of the one or more primary output terminals; and
a primary connecting member, the primary connecting member being configurable in a first primary configuration and a second primary configuration, the first primary configuration being adapted to provide primary conductivity between the transformer and the primary junction module and the second primary configuration being adapted to not having primary conductivity between the transformer and the primary junction module, and the primary connecting member being adapted to adjust from either of the first primary configuration and the second primary configuration to the other of the first primary configuration and the second primary configuration, without substantially affecting the primary conductivity between the one or more primary input terminals and the at least one of the one or more primary output terminals.

2. The transformer assembly of claim 1, wherein the transformer assembly is a compact integrated unit.

3. The transformer assembly of claim 1, further comprising one or more primary parking stations, wherein:
the primary connecting member comprises one or more primary connectors; and
the transformer assembly further comprises one or more amalgamated primary terminals, at least one of the one or more amalgamated primary terminals being adapted to engage at least one of the one or more primary connectors when the primary connection is in the first primary configuration, the first primary configuration resulting in primary conductivity between the at least one of the one or more primary connectors and the at least one of the one or more amalgamated primary terminals; and
the at least one of the one or more primary connectors is parked at a primary parking station when the at least one of the one or more primary connectors is in the second primary configuration.

4. The transformer assembly of claim 3, wherein:
at least one of the primary parking stations is an insulated primary parking port adapted to engage an energized primary connector; and
the at least one of the one or more primary connectors is adapted to remain energized when the primary connecting member is in the second primary configuration; and
the at least one of the one or more primary connectors engages the at least one of the one or more primary insulated parking ports when the primary connecting member is in the second primary configuration.

5. The transformer assembly of claim 4, wherein;
the at least one of the one or more primary insulated parking ports is disposed proximate the primary junction module, but not on the transformer.

6. The transformer assembly of claim 3, wherein the at least one of the one or more primary connectors is de-energized when the primary connecting member is in the second primary configuration.

7. The transformer assembly of claim 6, wherein:
at least one of the one or more primary parking stations is a primary parking port; and
the at least one of the one or more primary connectors is adapted to engage the at least one of the one or more primary parking ports when the primary connecting member is in the second primary configuration.

8. The transformer assembly of claim 7, wherein at least one of the one or more primary parking ports is disposed on the transformer.

9. An electric power distribution system, comprising:
one or more electric meters; and
the transformer assembly of claim 1, the transformer assembly of claim 1 further comprising:
one or more secondary blocks, at least one of the one or more secondary blocks being in secondary conductivity with at least one of the one or more electric meters; and
one or more secondary connecting members, at least one of the one or more secondary connecting members being adapted to (i) provide secondary conductivity between the transformer and at least one of the one or more secondary blocks, when the at least one of the one or more secondary connecting members is in a third configuration, and (ii) be substantially physically disconnected from the transformer when the at least one of the one or more secondary connecting members is in a fourth configuration, the at least one of the one or more secondary connecting members being adapted to adjust between the third and the fourth configurations.

10. An electric power distribution system, comprising:
one or more electric meters; and
the transformer assembly of claim 3, the transformer assembly of claim 3 further comprising:
one or more secondary blocks, the one or more secondary blocks being in secondary conductivity with at least one of the one or more electric meters, and wherein the at least one of the one or more secondary blocks is not mounted on the transformer; and
one or more secondary connecting members, at least one of the one or more secondary connecting members being adapted to (i) provide secondary conductivity between the transformer and at least one of the one or more secondary blocks, when the at least one of the one or more secondary connecting members is in a third configuration, and (ii) be substantially physically disconnected from the transformer when the at least one of the one or more secondary connecting members is in a fourth configuration, the at least of the one or more secondary connecting members being adapted to adjust between the third and fourth configurations.

11. The electric power distribution system of claim 10, wherein:
the transformer assembly further comprises one or more amalgamated secondary terminals; and
the at least one of the one or more secondary connecting members comprises one or more secondary connectors; and
at least one of the one or more amalgamated secondary terminals is adapted to engage at least one of the one or more secondary connectors when the at least one of the one or more secondary connecting members is in the third configuration.

12. The electric power distribution system of claim 11, wherein the at least one of the one or more secondary connectors is adapted to disengage from the at least one of the one or more amalgamated secondary terminals when the at least one of the one or more secondary connecting members is in the fourth configuration.

13. The electric power distribution system of claim 12, wherein:
the transformer assembly further comprises one or more secondary parking ports; and
at least one of the one or more secondary parking ports is not disposed on the transformer; and
the at least one of the one or more secondary connectors is adapted to engage the at least one of the one or more secondary parking ports when the at least one of the one or more secondary connecting members is in the fourth configuration.

14. A transformer assembly comprising:
a transformer; and
one or more secondary blocks; and
one or more secondary connecting members, at least one of the one or more secondary connecting members being adapted to (i) provide secondary conductivity between the transformer and at least one of the one or more secondary blocks, when the at least one of the one or more secondary connecting members is in a third configuration, and (ii) be substantially physically disconnected from the transformer when the at least one of the one or more secondary connecting members is in a fourth configuration, the at least one of the one or more secondary connecting members being adapted to adjust between the third and the fourth configurations.

15. The transformer assembly of claim 14, further comprising one or more secondary parking ports and one or more amalgamated secondary terminals, wherein:
at least one of the one or more secondary parking ports is not disposed on the transformer; and
at least one of the one or more secondary connecting members comprises one or more secondary connectors; and
at least one of the one or more amalgamated secondary terminals is adapted to engage at least one of the one or more secondary connectors when the one or more secondary connecting members is in the third configuration; and
the at least one of the one or more secondary connectors is adapted to being disengaged from the at least one of the one or more amalgamated secondary terminals when at least one of the one or more secondary connecting members is in the fourth configuration; and
the at least one of the one or more secondary connectors is adapted to engage at least one of the one or more secondary parking ports when at least one of the one or more secondary connecting members is in the fourth configuration.

16. A method of maintaining a transformer assembly, comprising:
providing a transformer assembly, the transformer assembly comprising:
a transformer; and
a primary parking port; and
a primary junction module, the primary junction module comprising (i) one or more primary input terminals, and, (ii) one or more primary output terminals, one of the one or more primary input terminals having primary conductivity with at least one of the one or more primary output terminals; and
an amalgamated primary terminal; and
a primary connecting member, the primary connecting member comprising a primary connector, and having (i) a first primary configuration adapted to provide primary conductivity between the transformer and the primary junction module, the first primary configuration comprising the primary connector being engaged with the amalgamated primary terminal, (ii) a second primary configuration adapted to not have primary conductivity between the transformer and the primary junction module, the second primary configuration comprising the primary connector being disengaged from the amalgamated primary terminal, and, (iii) being readily adjustable from either of the first primary and second primary configurations to the other of the first primary and second primary configurations, without interrupting power to the primary junction module or substantially affecting the primary conductivity between the one of the one or more primary input terminals and the at least one of the one or more primary output terminals; and
adjusting the primary connecting member to the second primary configuration; and
parking the primary connector at the primary parking port.

17. The method of maintaining the transformer assembly of claim 16, further comprising removing the transformer from the transformer assembly while the primary connector remains energized and parked at the parking port.

18. The method of maintaining the transformer assembly of claim 16, wherein the transformer assembly further comprises:
one or more secondary blocks; and
one or more secondary power lines, the one or more secondary power lines being in secondary conductivity with at least one of the one or more secondary blocks, wherein the transformer is adapted to be readily removed from the transformer assembly without interrupting primary conductivity between the one or more secondary power lines and the at least one or more secondary blocks; and
one or more secondary connecting members, at least one of the one or more secondary connecting members being adapted to (i) provide secondary conductivity between the transformer and at least one of the one or more secondary blocks, when the at least one of the one or more secondary connecting members is in a third configuration, and (ii) be substantially physically disconnected from the transformer when the at least one of the one or more secondary connecting members is in a fourth configuration, the at least one of the one or more secondary connecting members being adapted to adjust between the third and fourth configurations; and
adjusting the at least one of the one or more secondary connecting members to the fourth configuration.

19. The method of maintaining the transformer assembly of claim 16, further comprising removing the transformer from the transformer assembly while the primary connector is de-energized and parked at the parking port.

20. A method of maintaining a transformer assembly, comprising:
providing an electric power distribution system, the electric power distribution system comprising:
one or more metered secondary power lines; and
a transformer assembly, the transformer assembly comprising:
one or more secondary blocks, at least one of the one or more secondary blocks being coupled to at least one of the one or more metered secondary power lines; and
a transformer; and
removing the transformer from the transformer assembly, the at least one of the one or more secondary blocks remaining coupled to the at least one of the one or more metered secondary power lines when the transformer is removed.

21. The method of maintaining a transformer assembly of claim 20, further comprising adjusting one or more secondary connecting members to a fourth configuration, the transformer assembly further comprising the one or more secondary connecting members, at least one of the one or more secondary connecting members being adapted to (i) provide secondary conductivity between the transformer and at least one of the one or more secondary blocks, when the at least one of the one or more secondary connecting members is in a third configuration, and (ii) be substantially physically disconnected from the transformer when the one or more secondary connecting members is in a fourth configuration, the at least one of the one or more secondary connecting members being adapted to adjust between the third and fourth configurations.

22. The method of maintaining a transformer assembly of claim 21, wherein the at least one of the one or more secondary connecting member engages a parking port when the at least one of the one or more secondary connecting members is in the fourth configuration, the transformer assembly further comprising the parking port.
